(19) United States
(12) Patent Application Publication
(10) Pub. No.: US 2011/0105028 A1
(43) Pub. Date: May 5, 2011

(54) MOBILE TERMINAL AND COMMUNICATION METHOD FOR DETERMINING A COMMUNICATION PROTOCOL

(75) Inventors: Seung-dong YU, Osan-si (KR); Woo-Yong Chang, Yongin-si (KR); Seong-Il Hahm, Siheung-si (KR); Se-jun Park, Yongin-si (KR); Min-jeong Moon, Seongnam-si (KR)

(73) Assignee: Samsung Electronics Co., Ltd., Suwon-si (KR)

(21) Appl. No.: 12/910,499

(22) Filed: Oct. 22, 2010

(30) Foreign Application Priority Data
Oct. 30, 2009 (KR) 10-2009-0104011

(51) Int. Cl. H04W 80/00; H04W 24/02; H04W 88/02

(52) U.S. Cl. 455/41.2; 455/67.11; 455/67.7

(57) ABSTRACT

A mobile terminal and method for communicating through an optimum communication protocol selected from among a plurality of communication protocols. The mobile terminal includes a communication unit which communicates with a counterpart mobile terminal by a plurality of communication protocols in a network; a signal processor which processes a signal transmitted from or received by the communication unit; a display unit which displays thereon a processed signal; and a controller which controls the communication unit to communicate with the counterpart mobile terminal by an optimum communication protocol among the plurality of communication protocols.

### PRIORITY

This application claims priority under 35 U.S.C. §119(a) to Korean Patent Application No. 10-2009-0104011, filed on Oct. 30, 2009 in the Korean Intellectual Property Office, the entire contents of which are incorporated herein by reference.

### BACKGROUND

1. Field of Invention

The present invention relates generally to a mobile terminal and a communication method, and more particularly, to a mobile terminal and a communication method for performing community communication.

2. Description of the Related Art

Due to the development of various communication methods and protocols, the variety of communication protocols between terminals has increased.

The development of such communication protocols extend distribution of the wireless Internet and enables various contents to be supplied to a mobile phone.

Even though there are an increasing variety of communication protocols, a user of a terminal may not be well-aware of the current communication protocol of the terminal, nor aware of an optimum communication protocol.

### SUMMARY OF THE INVENTION

Accordingly, at least one embodiment of the present invention provides a mobile terminal and method for communicating through an optimum communication protocol selected from among a plurality of communication protocols.

Another embodiment of the present invention provides a mobile terminal and a communication method that includes an interface for a user to select a communication protocol when a communication environment is changed.

Still another embodiment provides a mobile terminal and a communication method including an Internet connection between mobile terminals communicating according to different communication protocols.

Yet another embodiment provides a mobile terminal and a communication method for routing information of mobile terminals communicating according to different communication protocols.

The foregoing and/or other aspects may be achieved by providing a mobile terminal including a communication unit for communicating with a counterpart mobile terminal according to a plurality of communication protocols in a network; a signal processor for processing a signal to be transmitted to the communication unit or received from the communication unit; a display unit for displaying the processed signal; and a controller for controlling the communication unit to communicate with the counterpart mobile terminal according to an optimum communication protocol selected from among the plurality of communication protocols.

The foregoing and/or other aspects may be achieved by providing a communication method of a mobile terminal which communicates with a counterpart mobile terminal by a plurality of communication methods in a network, the communication method including monitoring a communication environment in which the mobile terminal communicates with the counterpart mobile terminal; determining an optimum communication protocol according to the monitored communication environment; and communicating with the counterpart mobile terminal according to the determined optimum communication protocol.

The communicating method further includes displaying, by a display unit of the mobile terminal, a changed communication protocol on the display unit if the optimum communication protocol is changed.

The communicating method further includes transmitting information regarding a change of the communication protocol to the counterpart mobile terminal if the optimum communication protocol is changed.

The communicating method further includes changing the communication protocol if the counterpart mobile terminal transmits a signal indicating an acceptance of the change of the communication protocol.

The communicating method further includes if mobile terminal receives, from the counterpart mobile terminal, a request for changing the communication protocol to a requested communication call, communicating with the counterpart mobile terminal according to the requested communication protocol.

The communicating method further includes connecting to a predetermined Internet server according to a first communication protocol; communicating with the counterpart mobile terminal according to a second communication protocol that is different from the first communication protocol; and routing information between the Internet server and the counterpart mobile terminal.

The communicating method further includes generating a community in which the mobile terminal shares information with the counterpart mobile terminal through the Internet server, wherein routing information between the Internet server and the counterpart mobile terminal includes routing information shared in the network.

The communicating method further includes, if the mobile terminal communicates with a first counterpart mobile terminal according to a first communication protocol, and communicates with a second counterpart mobile terminal according to a second communication protocol that is different from the first communication protocol: transcoding information received from the first counterpart mobile terminal into first transcoded information having a format appropriate for the second communication protocol; transmitting the first transcoded information to the second counterpart mobile terminal, transcoding information received from the second counterpart mobile terminal into second transcoded information having a format appropriate for the first communication protocol; and transmitting the second transcoded information to the first counterpart mobile terminal.

### BRIEF DESCRIPTION OF THE DRAWINGS

The above and/or other aspects will become apparent and more readily appreciated from the following description of the embodiments, taken in conjunction with the accompanying drawings, in which:

FIG. 1 is a control block diagram of a mobile terminal according to an embodiment of the present invention;

FIG. 2 is a control flowchart of a communication method performed by the mobile terminal in FIG. 1;

FIG. 3 is a control flowchart of another communication method performed by the mobile terminal in FIG. 1;

FIG. 4 is a control flowchart of another communication method performed by the mobile terminal in FIG. 1; and

FIG. 5 illustrates another communication method performed by the mobile terminal in FIG. 1.

### DETAILED DESCRIPTION OF EMBODIMENTS OF THE PRESENT INVENTION

Below, embodiments will be described in detail with reference to accompanying drawings so as to be easily realized by a person having ordinary knowledge in the art. The embodiments may be embodied in various forms without being limited to the embodiments set forth herein. Descriptions of well-known parts are omitted for clarity, and like reference numerals refer to like elements throughout.

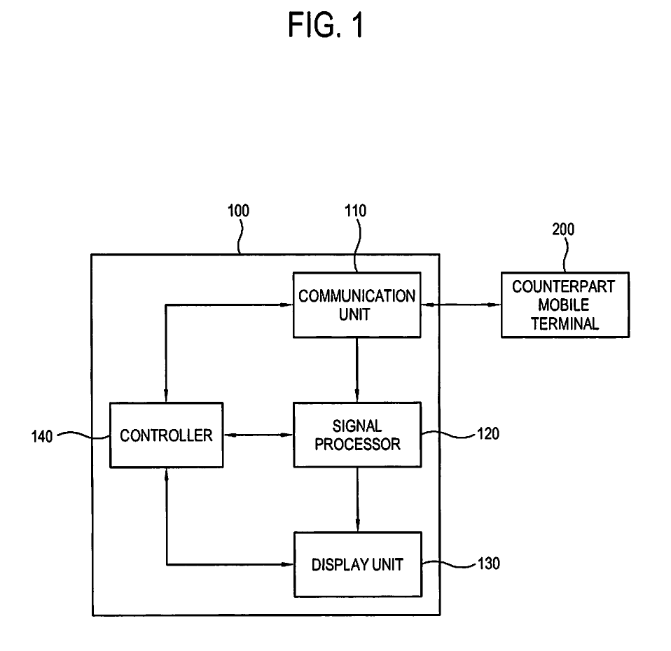

FIG. 1 is a control block diagram of a mobile terminal 100 according to an embodiment of the present invention.

The mobile terminal 100 includes a communication unit 110, a signal processor 120, a display unit 130, and a controller 140 for controlling these elements. The mobile terminal 100 may communicate with at least one counterpart mobile terminal 200. The mobile terminal 100 and/or the counterpart mobile terminal 200 may any of various devices that communicate in a network, such as mobile phones having audio and video telephone call capabilities, laptop computers, Personal Digital Assistants (PDAs), or Motion Picture Experts' Group (MPEG) audio layer-3 (MP3) devices.

The communication unit 110 may communicate with the counterpart mobile terminal 200 through a plurality of communication protocols in a network. The communication unit 110 may communicate with the counterpart mobile terminal 200 through a plurality of communication protocols, instead of only one particular communication protocol, and may change a communication protocol according to a communication environment or according to a control of the controller 140. The communication unit 110 may communicate according various communication standards such as WI-FI®, BLUETOOTH®, or ZIGBEE®, and may be connected to a plurality of counterpart mobile terminals 200 through ad-hoc communications. In this case, the communication unit 110 may include a WI-FI®, BLUETOOTH® or ZIGBEE® communication module. The communication unit 110 may perform a WI-FI® or Wireless Local Area Network (WLAN) communication and form an infrastructure network with the plurality of counterpart mobile terminals 200. To do the foregoing, the communication unit 110 may include a Wi-Fi or WLAN communication module. The communication unit 110 may communicate with the counterpart mobile terminal 200 by using a service provided by a Mobile Network Operator (MNO), and currently communicates with the counterpart mobile terminal 200 in a 3^{rd} Generation (3G) network.

The signal processor 120 may process a signal transmitted to or received from the communication unit 110. More specifically, the signal processor 120 may encode, decode or demodulate signals.

The display unit 130 displays thereon an image based on a signal processed by the signal processor 120. The display unit 130 includes a display panel such as a Liquid Crystal Display (LCD) panel, an Organic Light Emitting Display (OLED) panel or a Plasma Display Panel (PDP). The display unit 130 includes a panel driver to drive the display panel.

The mobile terminal 100 may also include a user input unit (not shown) according to embodiments of the present invention. The user input unit receives a user's input related to communication functions and an Internet connection of the mobile terminal 100, such as starting a communication, generating a community (i.e., an online space for chatting or other communication between users connected to a network) or ending a communication. The user input unit may include a touch screen, a touch pad and a key button.

The controller 140 controls the communication unit 110 to communicate with the counterpart mobile terminal 200 according to an optimum communication protocol selected from among a plurality of communication protocols. Depending on a user's location, i.e., depending on a communication environment of the mobile terminal 100, there can be a plurality of communication protocols that may be applied by the mobile terminal 100. The mobile terminal 100 may also communicate according to a single communication protocol, depending on the communication environment. The controller 140 monitors a communication environment in which the mobile terminal 100 communicates with the counterpart mobile terminal 200, and determines an optimum communication protocol to be applied to the monitored communication environment. If the mobile terminal 100 may communicate by a plurality of communication protocols, the controller 140 provides a communication protocol that is determined to be the most appropriate protocol for a user, in consideration of the communication costs, e.g., in consideration of whether the communication cost is free of charge or a paid service, a data transmission rate, a communication frequency band, etc. According to the monitoring result, if a 3G network and WI-FI® are available for communication between the mobile terminal 100 and the counterpart mobile terminal 200, and the two mobile terminals 100 and 200 are present within a certain range from a WI-FI® access point, the controller 140 may control the two mobile terminals 100 and 200 to communicate with each other by WI-FI®, which may provide a higher-quality signal or data transmission rate.

The controller 140 may send or receive a proving packet to monitor the communication environment in which the mobile terminal 100 communicates with the counterpart mobile terminal 200, measure an intensity of signals while transmitting or receiving certain signals, or calculate a signal rate based on the intensity of the signals. In case of a communication protocol that supports an additional signal channel to monitor the communication environment, the controller 140 monitors the communication environment by using a predetermined signal channel. In case of a communication protocol that does not support an additional exclusive channel, the controller 140 monitors the communication environment by various known methods. The controller 140 may set an optimum communication protocol by monitoring the communication environment at regular intervals or apply another communication protocol if the communication environment meets particular conditions. For example, if the mobile terminal 100 communicates with the counterpart mobile terminal 200 in a 3G network, the mobile terminal 100 may determine whether a WI-FI® communication network is available for use on a regular basis. Otherwise, if the mobile terminal 100 communicates with the counterpart mobile terminal 200 by Wi-Fi, the controller 140 may determine that the communication environment is changed and may examine a new communication protocol upon sharp decline in signal transmission/reception rate or in the intensity of received signals, i.e., if the current communication environment changes sharply, the controller 140 may set a new, optimum communication protocol.

According to another embodiment of the present invention, the controller 140 may examine an optimum communication protocol by using information received from the counterpart mobile terminal 200. The counterpart mobile terminal 200 may transmit, to the mobile terminal 100, information regarding a special circumstance such as the case where another communication protocol is available or a circumstance where communication cannot be maintained by the current communication protocol. Upon reception of such information, the controller 140 may monitor the current communication environment and determine an optimum communication protocol.

The controller 140 may determine an optimum communication protocol according to a characteristic of contents transmitted between the mobile terminal 100 and the counterpart mobile terminal 200. Depending on whether a content is a text or a still image or a video, the controller 140 may set an optimum communication protocol in consideration of a content transmission rate or bandwidth.

The controller 140 may display on the display unit 130 information regarding the current optimum communication protocol.

If the optimum communication protocol is changed as a result of movement of the mobile terminal 100 or a change in the communication environment, the controller 140 displays, on the display unit 130, information on the changed communication protocol, and transmits, to the counterpart mobile terminal 200, information on the changed communication protocol. For example, if the mobile terminal 100 communicates with the counterpart mobile terminal 200 in a 3G network due to a movement of the mobile terminal, instead of WI-FI® communication used before a user's movement, the controller 140 notifies a user of a necessity for changing the communication protocol through the display unit 130. The controller 140 also notifies the counterpart mobile terminal 200 of the communication change in the mobile terminal 100, and enables a counterparty to determine whether to maintain the communication by the changed communication protocol. Since a counterparty may not desire to maintain the communication when the communication protocol is changed from a free communication protocol, such as WI-FI®, to a paid communication protocol, such as 3G, the user of the counterpart terminal 200 is provided with an opportunity to determine whether to change the communication protocol.

The controller 140 may change the communication protocol from a WI-FI® protocol to a 3G network protocol upon receiving a signal for accepting the change of the communication protocol from the counterpart mobile terminal 200. More specifically, the controller 140 determines and provides, to a user, an optimum communication protocol, and changes the communication protocol according to a user's selection.

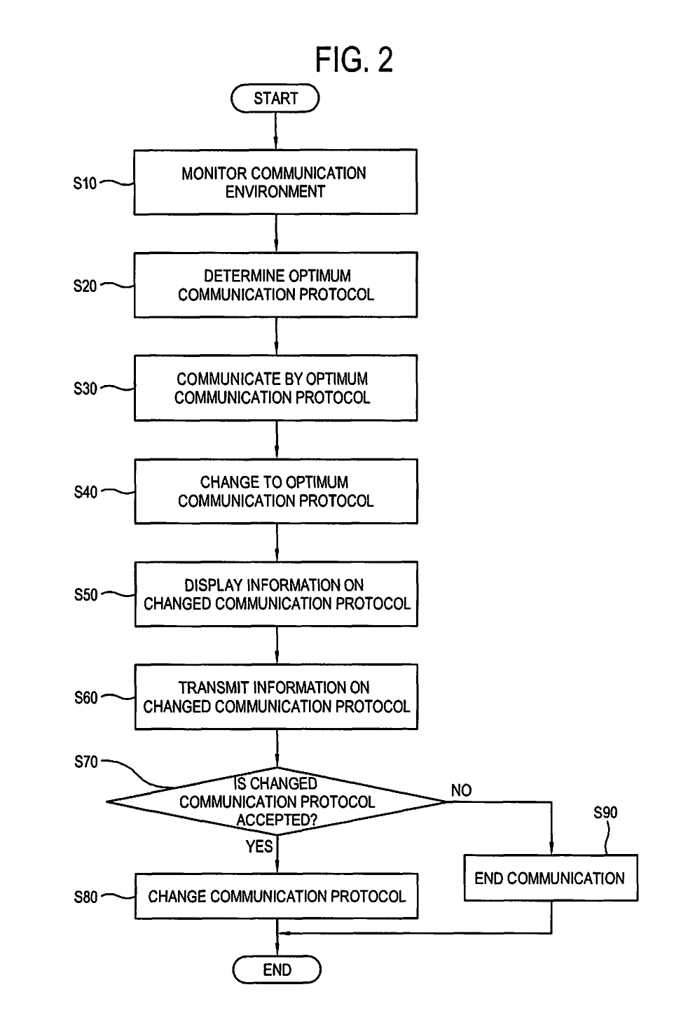

FIG. 2 is a control flowchart of the communication method of the mobile terminal 100 described with reference to FIG. 1 according to an embodiment of the present invention.

Referring to FIG. 2, the controller 140 monitors the communication protocols available in the communication environment where a user is located currently, in step S10, and determines an optimum communication protocol, in step S20. The optimum communication protocol may be determined according to a technical standard such as a quality of a communication state, a data transmission rate, and/or communication costs corresponding to each respective communication protocol. As a priority for a plurality of communication protocols is set, the controller 140 may control the communication unit 110 to communicate with the counterpart mobile terminal 200 according to a communication protocol having a higher priority than other communication protocols. The priority may be set when the mobile terminal 100 is manufactured, or changed by a user. When the priority is set, the communication unit 110 may communicate with the counterpart mobile terminal 200 according to the priority, instead of communicating by the monitored optimum communication protocol. The controller 140 may prioritize to a communication protocol that is most frequently used by a user among a plurality of communication protocols. For example, if a user prefers using a paid communication even, in s place where, free communication is available, the controller 140 may communicate with the counterpart mobile terminal 200 by the paid communication protocol that is used most frequently by a user. If a user sets or changes the priority, the controller 140 may change the communication protocol in response to a user's preference. The priority may also be set according to large or small communication costs incurred by communication.

If the optimum communication protocol is determined, the controller 140 controls the communication unit 110 to communicate with the counterpart mobile terminal 200 according to the determined optimum communication protocol, in step S30.

If the communication environment is changed by a user's movement and the optimum communication protocol is changed accordingly, in step S40, the controller 140 displays, on the display unit 130, an indication of the changed communication protocol, in step S50, and transmits, to the counterpart mobile terminal 200, the information regarding the changed communication protocol, in step S60.

The controller 140 determines whether the counterpart mobile terminal 200 has transmitted a signal accepting the changed communication protocol, in step S70. If the signal accepting the changed communication protocol is transmitted by the counterpart mobile terminal 200, the controller 140 changes the communication protocol and maintains the communication with the counterpart mobile terminal 200, in step S80.

Meanwhile, if a signal rejecting the a change communication protocols is transmitted by the counterpart mobile terminal 200, the controller 140 ends the communication with the counterpart mobile terminal 200, in step S90.

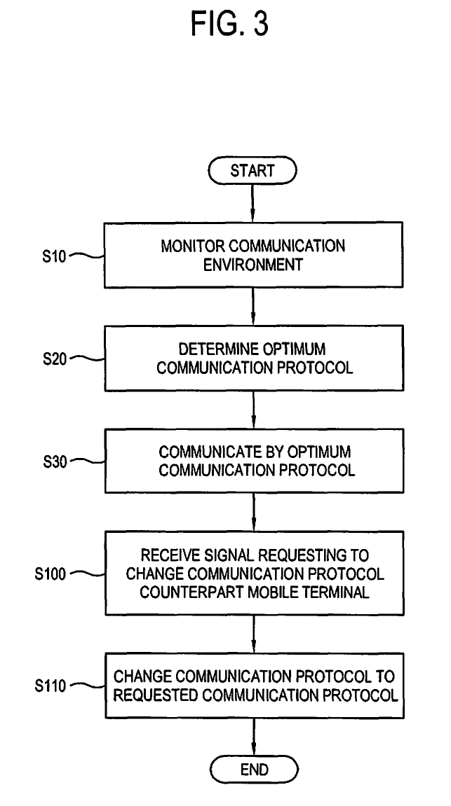

FIG. 3 is a control flowchart of another communication method of the mobile terminal 100 in FIG. 1. The communication process performed, by the controller 140, according to an optimum communication protocol, which includes the operations of steps S10 to S30 in FIG. 2.

Even when the communication is already being performed according to an optimum communication protocol, the communication environment of the counterpart mobile terminal 200 may change.

When the communication environment changes in such a case, the controller 140 receives a request signal according to the changed communication protocol from the counterpart mobile terminal 200, in step S100.

According to a user's intent, the controller 140 changes the current communication protocol to the requested communication protocol, in step S110. If to the mobile terminal 100 does not receive user input for changing the communication protocol to the requested communication protocol, the controller 140 may end the communication with the counterpart mobile terminal 200.

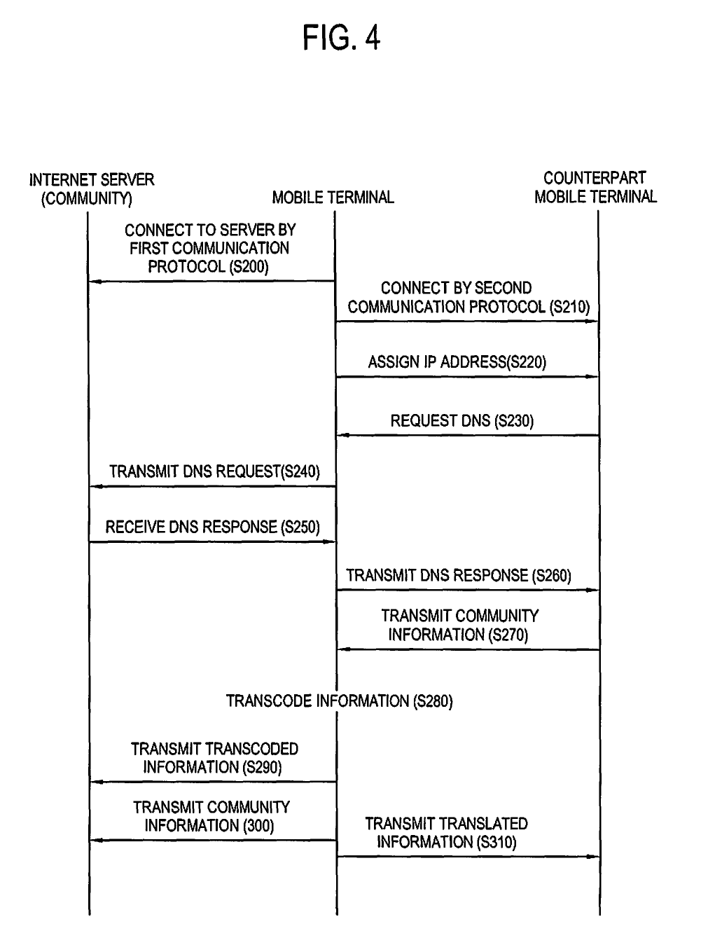

FIG. 4 is a control flowchart of another communication method of the mobile terminal 100 in FIG. 1 according to another embodiment of the present invention. Referring to FIG. 4, the mobile terminal 100 may be connected to the Internet server according to a first communication protocol, and may communicate with the counterpart mobile terminal 200 according to a second communication protocol that is different from the first communication protocol. For example, the first communication protocol may include 3G network communication provided by a mobile network operator, and the second communication protocol may include one of WI-FI® and BLUETOOTH® communication protocols.

First, the mobile terminal 100 is connected to the Internet server by the first communication protocol, in step S200. After being connected to the Internet through a core network of the mobile network operator, the mobile terminal 100 executes an Internet Connection Sharing (ICS) function. A user may generate a community to share information with other users through a particular Internet server. A user may be connected to a Social Network Service (SNS) website or generate a community for a chat room or message transmission and reception.

After generating the community, the mobile terminal 100 starts the communication with the counterpart mobile terminal 200 by the second communication protocol such as WI-FI® or BLUETOOTH®, in step S210. In a case where the optimum communication protocol for a user's mobile terminal 100 and the counterpart mobile terminal 200 is not the first communication protocol but the second communication protocol, a user assigns an IP address to the counterpart mobile terminal 200 in order to provide the counterpart mobile terminal 200 with the Internet environment, which was connected according to the first communication protocol, according to the second communication protocol, in step S220. A user may request for the counterpart mobile terminal 200 to be connected to the Internet server or community where the mobile terminal 100 is currently connected while assigning the IP address.

Upon receiving the IP address, the counterpart mobile terminal 200 requests a Domain Name System (DNS), in step S230, and the mobile terminal 100 transmits, to the Internet server, the DNS request signal of the counterpart mobile terminal 200, in step S240.

After transmission of the DNS request signal of the counterpart mobile terminal 200, the mobile terminal 100 receives the DNS response from the Internet server, in step S250, and transmits the DNS to the counterpart mobile terminal 200, in step S260. In this case, the mobile terminal 100 acts as a Dynamic Host Configuration Protocol (DHCP) server for the counterpart mobile terminal 200.

Through the above-described process, the counterpart mobile terminal 200 is connected to the Internet server and a user of the mobile terminal 100 and the counterparty user of the counterpart mobile terminal 200 may share information in the community.

If the counterparty inputs community information through the counterpart mobile terminal 200, in step S270, the mobile terminal 100 translates the community information by using a Network Address Translator (NAT) function included in the Internet connection sharing function, in step S280. Through this process, the mobile terminal 100 routes the information shared between the Internet server and the counterpart mobile terminal 200. The translated information is transmitted to the Internet server according to the first communication protocol, in step S290.

A user may also input the community information, and such community information is transmitted to the Internet server, in step 300, and is translated and transmitted to the counterpart mobile terminal 200, in step S310.

According to the embodiment of the present invention described with reference to FIG. 4, the counterparty may be connected to the Internet server through free WI-FI® or BLUETOOTH® communication protocols without using a paid 3G network, and share information with a user through the Internet server.

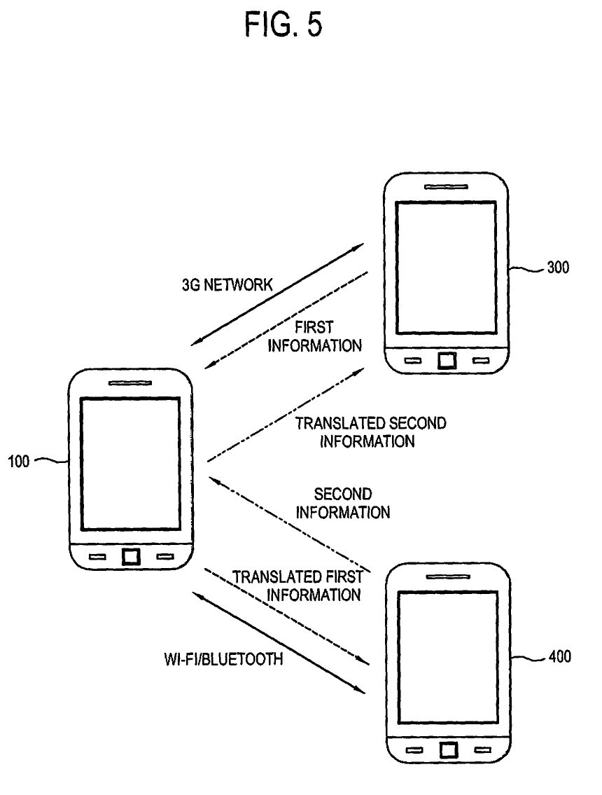

FIG. 5 illustrates a communication method of the mobile terminal 100 in FIG. 1 according to another embodiment of the present invention. Referring to FIG. 5, the mobile terminal 100 communicates with a first counterpart mobile terminal 300 and a second counterpart mobile terminal 400 according to different communication protocols. The mobile terminal 100 communicates with the first counterpart mobile terminal 300 through a 3G network, and with the second counterpart mobile terminal 400 according to a WI-FI® or BLUETOOTH® communication protocol.

The controller 140 of the mobile terminal 100 transcodes information received from the first counterpart mobile terminal 300 into a format appropriate for the second communication protocol, transmits the transcoded information to the second counterpart mobile terminal 400, transcodes information received from the second mobile terminal 400 into a format appropriate for the first communication protocol, and transmits the transcoded received information to the first mobile terminal 300. The mobile terminal 100 acts as a host or server for communication with the first and second counterpart mobile terminals 300 and 400. The mobile terminal 100 may generate a community in which three terminals 100, 300 and 400 may share information. In this case, the mobile terminal 100 generates a User Interface (UI) such as a chat room shared with the first and second mobile terminals 300 and 400, transmits the generated UI to the terminals 300 and 400, and transmits information input by the terminals 300 and 400 after changing the input information into respective formats appropriate for the different communication protocols.

If the communication environment of one of the terminals 100, 300 and 400 changes during the communication, the communication changing method described with reference to FIGS. 2 and 3 may be applied to the embodiment of the invention described with reference to FIG. 5.

The present invention relates to a mobile terminal that communicates according to a plurality of communication protocols, determines an optimum communication protocol, and routes information between communicating mobile terminals according to different communication protocols.

As described above, a mobile terminal and a communication method of the same according to embodiments of the present invention communicate according to an optimum communication protocol selected from among a plurality of communication protocols.

Also, a mobile terminal and a communication method of the same according to another embodiments of the present invention provide an interface for a user to select a communication protocol when a communication environment changes.

Further, a mobile terminal and a communication method of the same according to other embodiments of the present invention provide an Internet connection between mobile terminals communicating according to different communication protocols.

Further, a mobile terminal and a communication method thereof according to other embodiments of the present invention route information of mobile terminals communicating according to different communication protocols.

Although a few embodiments have been shown and described, it will be appreciated by those skilled in the art that changes may be made in these embodiments without departing from the principles and spirit of the invention, the scope of which is defined in the appended claims and their equivalents.

What is claimed is:

1. A mobile terminal comprising:
a communication unit for communicating with a counterpart mobile terminal according to a plurality of communication protocols in a network;
a signal processor for processing a signal to be transmitted to the communication unit or received from the communication unit;
a display unit for displaying the processed signal; and
a controller for controlling the communication unit to communicate with the counterpart mobile terminal according to an optimum communication protocol selected from among the plurality of communication protocols.

2. The mobile terminal according to claim 1, wherein the controller monitors a communication environment in which the mobile terminal communicates with the counterpart mobile terminal, and determines the optimum communication protocol according to the monitored communication environment.

3. The mobile terminal according to claim 2, wherein the controller monitors, on a regular basis, the communication environment in which the mobile terminal communicates with the counterpart mobile terminal.

4. The mobile terminal according to claim 1, wherein the controller sets, as the optimum communication protocol, a communication protocol having a fastest signal transmission rate, from among the plurality of communication protocols.

5. The mobile terminal according to claim 1, wherein the controller determines, upon transmitting content to the counterpart mobile terminal or receiving content from the counterpart mobile terminal, the optimum communication protocol based on a characteristic of the transmitted content or the received content, respectively.

6. The mobile terminal according to claim 1, wherein the display unit displays, if the optimum communication protocol is changed, the changed optimum communication protocol.

7. The mobile terminal according to claim 1, wherein the controller transmits, to the counterpart mobile terminal, if the optimum communication protocol is changed, information regarding the changed optimum communication protocol.

8. The mobile terminal according to claim 7, wherein the controller changes the communication protocol upon receiving, from the counterpart mobile terminal, a signal indicating an acceptance of the change of the communication protocol.

9. The mobile terminal according to claim 1, wherein, if a request for changing the communication protocol to a requested communication protocol is received from the counterpart mobile communication terminal, the controller controls the communication unit to communicate with the counterpart mobile terminal according to the requested communication protocol.

10. The mobile terminal according to claim 1, wherein a priorities are set for the plurality of communication protocols, and the controller controls the communication unit to communicate with the counterpart mobile terminal according to a communication protocol having a higher priority than other communication protocols.

11. The mobile terminal according to claim 10, wherein the controller assigns a higher priority to a communication protocol that is most frequently used by a user from among the plurality of communication protocols.

12. The mobile terminal according to claim 1, wherein the controller routes information between an Internet server and the counterpart mobile terminal when a predetermined Internet server is connected to the mobile terminal according to a first communication protocol and the counterpart mobile terminal communicates with the mobile terminal according to a second communication protocol that is different from the first communication protocol.

13. The mobile terminal according to claim 12, wherein the controller assigns an Internet Protocol (IP) address to the counterpart mobile terminal, transmits, to the Internet server, a Domain Name System (DNS) request received from the counterpart mobile terminal, and transmits, to the counterpart mobile terminal, a DNS response received from the Internet server.

14. The mobile terminal according to claim 13, wherein the controller generates a community in the Internet server for sharing information with the counterpart mobile terminal, and routes shared information through the community.

15. The mobile terminal according to claim 12, wherein the first communication protocol comprises a Third Generation (3G) network communication and the second communication protocol includes one of a WI-FI® protocol and a BLUETOOTH® protocol.

16. The mobile terminal according to claim 1, wherein, if a first counterpart mobile terminal communicates according to a first communication protocol and a second counterpart mobile terminal communicates according to a second communication protocol that is different from the first communication protocol, the controller transcodes information received from the first counterpart mobile terminal into first transcoded information having a format appropriate for the second communication protocol, transmits the first transcoded information to the second counterpart mobile terminal, transcodes information received from the second counterpart mobile terminal into second transcoded information having a format appropriate for the first communication protocol, and transmits the second transcoded information to the first counterpart mobile terminal.

17. A communication method performed by a mobile terminal that communicates with a counterpart mobile terminal according to a plurality of communication protocols in a network, the communication method comprising:
monitoring a communication environment in which the mobile terminal communicates with the counterpart mobile terminal;
determining an optimum communication protocol according to the monitored communication environment; and
communicating with the counterpart mobile terminal according to the determined optimum communication protocol.

18. The communication method according to claim 17, wherein monitoring the communication environment includes monitoring the communication environment on a regular basis.

19. The communication method according to claim 17, wherein determining the optimum communication protocol includes determining a communication protocol that has a fastest signal transmission rate among the plurality of communication protocols to be the optimum communication protocol.

20. The communication method according to claim 17, further comprising displaying, by a display unit of the mobile terminal, a changed communication protocol on the display unit if the optimum communication protocol is changed.

21. The communication method according to claim 17, further comprising transmitting information regarding a change of the communication protocol to the counterpart mobile terminal if the optimum communication protocol is changed.

22. The communication method according to claim 21, further comprising changing the communication protocol if the counterpart mobile terminal transmits a signal indicating an acceptance of the change of the communication protocol.

23. The communication method according to claim 17, further comprising if mobile terminal receives, from the counterpart mobile terminal, a request for changing the communication protocol to a requested communication call, communicating with the counterpart mobile terminal according to the requested communication protocol.

24. The communication method according to claim 17, further comprising:
connecting to a predetermined Internet server according to a first communication protocol;
communicating with the counterpart mobile terminal according to a second communication protocol that is different from the first communication protocol; and
routing information between the Internet server and the counterpart mobile terminal.

25. The communication method according to claim 24, wherein the routing the information includes:
assigning an Internet Protocol (IP) address to the counterpart mobile terminal;
receiving a Domain Name System (DNS) request from the counterpart mobile terminal;
transmitting the DNS request to the Internet server; and
transmitting, to the counterpart mobile terminal, a DNS response received from the Internet server.

26. The communication method according to claim 24, further comprising generating a community in which the mobile terminal shares information with the counterpart mobile terminal through the Internet server, wherein
routing information between the Internet server and the counterpart mobile terminal includes routing information shared in the network.

27. The communication method according to claim 24, wherein the first communication protocol includes a Third Generation (3G) network communication protocol and the second communication protocol includes at least one of a WI-FI® communication protocol and a BLUETOOTH® communication protocol.

28. The communication method according to claim 17, further comprising, if the mobile terminal communicates with a first counterpart mobile terminal according to a first communication protocol, and communicates with a second counterpart mobile terminal according to a second communication protocol that is different from the first communication protocol:
transcoding information received from the first counterpart mobile terminal into first transcoded information having a format appropriate for the second communication protocol;
transmitting the first transcoded information to the second counterpart mobile terminal,
transcoding information received from the second counterpart mobile terminal into second transcoded information having a format appropriate for the first communication protocol; and
transmitting the second transcoded information to the first counterpart mobile terminal.
